(19) United States
(12) Patent Application Publication
(10) Pub. No.: US 2024/0013201 A1
(43) Pub. Date: Jan. 11, 2024

(54) IN-GAME CRYPTOCURRENCY WALLETS

(71) Applicant: NFT Worlds, LLC, Redmond, WA (US)

(72) Inventors: Max Holmes, Redmond, WA (US); Braydon Batungbacal, University Place, WA (US)

(21) Appl. No.: 17/881,933

(22) Filed: Aug. 5, 2022

Related U.S. Application Data
(60) Provisional application No. 63/359,104, filed on Jul. 7, 2022.

(51) Int. Cl. G06Q 20/36; G06Q 30/02; G06Q 20/38; A63F 13/73

(52) U.S. Cl. CPC G06Q 20/3674; G06Q 30/0209; G06Q 20/3825; G06Q 20/3829; A63F 13/73; G06Q 2220/00

(57) ABSTRACT

A facility for operating a game on behalf of a player is described. The facility identifies an opportunity in the operation of the game to perform a cryptocurrency transaction with respect to the player, and identifies a cryptocurrency wallet belonging to the player. The facility creates a cryptocurrency transaction in accordance with the identified opportunity with respect to the identified cryptocurrency wallet, and causes the created cryptocurrency transaction to be signed by the identified cryptocurrency wallet. The facility causes the signed cryptocurrency transaction to be posted to a public blockchain by a cryptocurrency network.

### BACKGROUND

Massively multiplayer online role-playing games (“MMORPGs”) are an online role-playing games in which a very large number of people participate simultaneously. Some MMORPGs are implemented in a way that provides an in-game currency that is unique to the particular MMORPG. For example, the MMORPG World of Warcraft provides an in-game currency called gold: gold can be earned by a player while playing World of Warcraft, and can be spent by the player to purchase in-game items such as weapons, food, and skills. Conventionally, each player's in-game currency balance is stored and managed directly by the MMORPG's game engine as part of the player state that the game engine maintains for the player.

### BRIEF DESCRIPTION OF THE DRAWINGS

FIG. 1 is a block diagram showing some of the components typically incorporated in at least some of the computer systems and other devices on which the facility operates.

FIG. 2 is an invocation diagram showing the relationship between different code modules used in connection with the facility.

FIGS. 3A-3B are a flow diagram showing a process performed by the facility in some embodiments to support cryptocurrency transactions within the host game.

FIG. 4 is a display diagram showing a sample display presented by the facility in some embodiments to present an opportunity for a cryptocurrency transaction within the host-game.

FIG. 5 is a sample display presented by the facility in some embodiments to confirm an in-game cryptocurrency transaction.

FIG. 6 is a flow diagram showing a process performed by the facility in some embodiments to create a wallet on behalf of a player.

### DETAILED DESCRIPTION

The inventors have recognized that conventional approaches to implementing in-game currencies have significant disadvantages. One disadvantage is that players must rely on the developer and/or operator of the game to maintain in-game currency balances in a fair manner. Nothing prevents these inside actors from seizing a portion of a player's balance based upon the player's actions in the game, character type, or other factors. Such seizures can deprive a player of value that they invested heavily to build.

Another disadvantage is that even developers and operators who seek to maintain in-game currency balances in a fair manner may provide inadequate security for this feature of their game, permitting outside actors to steal, extinguish, devalue, etc., currency balances of innocent players. And effectively providing this level of security requires significant effort—initially, and on an ongoing basis—by developers with specialized expertise.

A further disadvantage is that these “native” in-game currencies exist only within the boundaries of the game. It is generally impossible to sell or donate a portion of the player's balance to another player or person wholly outside of the game. Thus, any sales or donations of native currency balances must occur within the game. This means that sales or donations can only be performed to the extent and in the way enabled by the game's developer and operator. It also means that a purchaser of native currency can pay for it using only other currencies that the game is capable of accessing; it is very typical for there to be none of these.

In response recognizing these disadvantages, the inventors have conceived and reduced to practice a software and/or hardware facility for providing support for using in a host game a cryptocurrency that is functionally independent of the host game (“the facility”). Here, the term “functionally independent” means that all transactions in the cryptocurrency are stored on a blockchain that is outside of and independent of the host game's game engine and the internal state it maintains.

The host game can award amounts of the cryptocurrency to players as payment for in-game activity, which they can spend in the game to purchase in-game items. Transactions of both of these types can be triggered by the host game's game engine, with respect to a cryptocurrency wallet owned by the player, as can cryptocurrency donations from one player to another. Where the player does not already own a suitable cryptocurrency wallet, the facility causes one to be created on the player's behalf.

All of the transactions that occur with respect to this wallet are maintained on a public blockchain, which allows the wallet's balance to be discerned from outside the host game, and the corresponding transactions to be audited. Also, the owner of the wallet can transact against the wallet from outside the host game, such as in a cryptocurrency exchange where amounts of the cryptocurrency can be bought and sold.

In some embodiments, the host game is a MMORPG, such as Minecraft. In some embodiments, the facility leverages third-party services, including player authentication; key management and signing; and cryptocurrency networks/blockchain administration.

By operating in some or all of the ways described above, the facility enables the host game to straightforwardly support payments of and with the functionally independent cryptocurrency, in a way that outsources from the host game currency management and associated security and control, and that permits access to and transacting with cryptocurrency balances outside the host game.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by outsourcing currency management and associated security and control from the host game, the facility reduces the processing burden imposed by the host game, enabling a larger number of instances of the host game to be executed on the same physical and/or virtual hardware, or the same number of instances of the host game to be executed on less powerful, less expensive hardware. Also, the ability to interface with and take advantage of third-party user authentication, credential management, and transaction execution services permits the selection of best-of-breed versions of these services capable of providing high levels of security, error resistance, resource efficiency, responsiveness, uptime, and extensibility, for example, without imposing the burden of their development, operation, and maintenance on the developer and operator of the host game or of the facility.

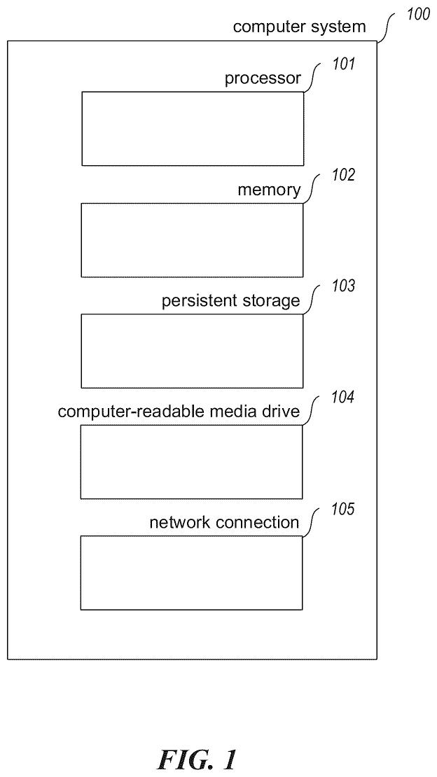

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

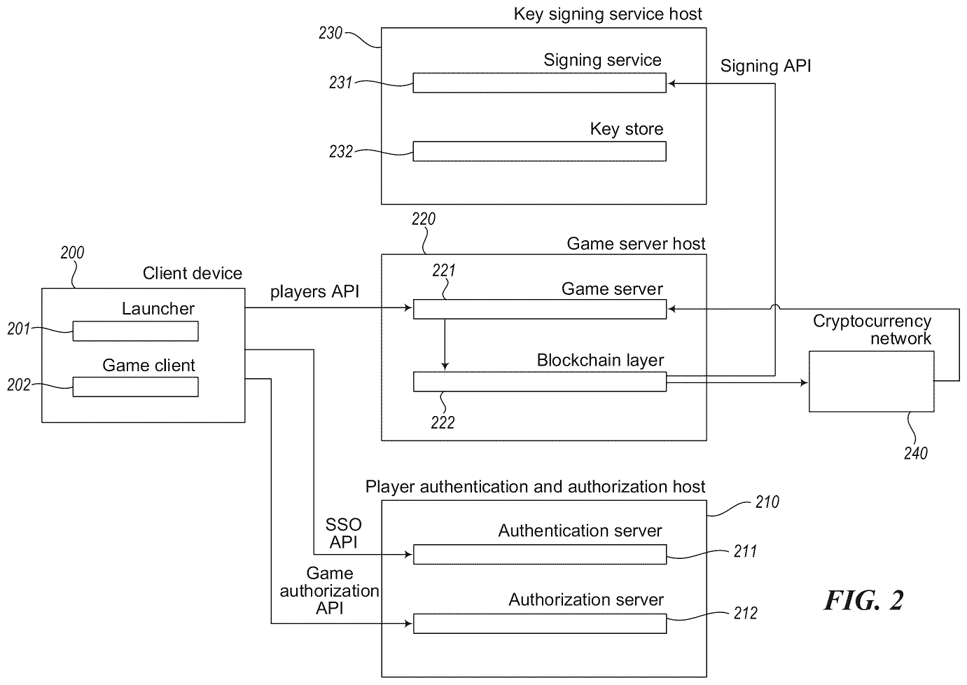

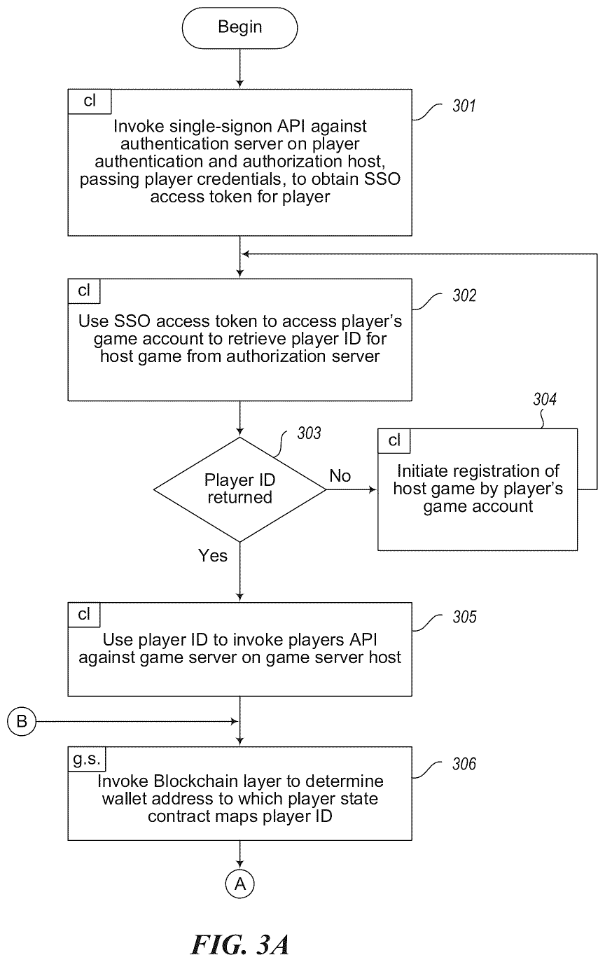

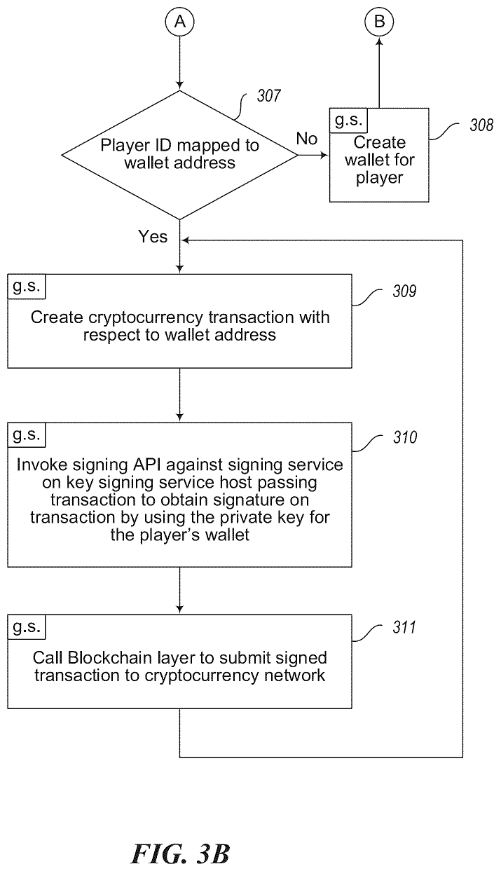

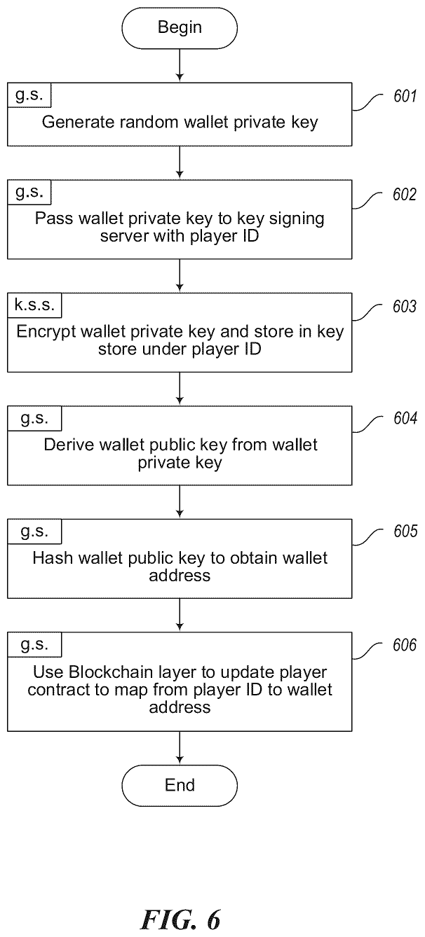

FIG. 2 is an invocation diagram showing the relationship between different code modules used in connection with the facility. Additional details about their interactions are discussed below in connection with FIGS. 3A-3B and 6.

In some embodiments, a player plays the host game using a client device 200. In various embodiments, a game launcher 201 and/or a game client 202 execute on the client device and interact as part of the operation of the facility. In particular, the client device begins a sign-on process on behalf of the player by invoking a single sign-on (“SSO”) API against authentication server software 211 executing on a player authentication and authorization host. In various embodiments, the hosts shown and described herein are one or more of physical servers, virtual servers, microservers, geographically distributed servers, etc. In some embodiments, the authentication server is an Azure Active Directory single sign-on server. In various embodiments, the client device passes various player credentials to the authentication server as part of the SSO API invocation. If the authentication server finds these credentials satisfactory, the authentication server returns to the client device data that the client device can provide as evidence that it is signed into the authentication server, such as an SSO token. The client device uses this SSO token or other evidence of being signed in in invoking a game authorization API against a game authorization server 212. While the authorization server is shown as executing on the same host as the authentication server, in some embodiments they execute on different hosts. In some embodiments, the authorization server is the Xbox Live gaming service, which maintains a list of purchased games and player IDs for those games for each registered player. The client device uses the game authorization API to determine whether the player is authorized to the host game, such as by having purchased it, entered into a subscription for it, qualified for free use of it, etc. If so, the client device retrieves the player identifier for this player and the host game. Otherwise, the client device gives the player an opportunity to purchase or otherwise authorize themselves to the host game with the authorization server. As a result of these interactions, the client device obtains the player's player ID for the host game.

The client device then uses this player ID, in some cases in connection with the SSO token, to invoke a players API against a game server 221 executing on a game server host 220. In some embodiments, this game server is a forked version of an externally provided game, such as Minecraft. In various embodiments, the host game server is enhanced to operate with the facility in some or all the following ways: to interact with a blockchain layer 222 provided as part of the facility that can create a wallet, create transactions against the wallet, and submit them to a cryptocurrency network; read aspects of a game definition state that relate to cryptocurrency transaction opportunities, such as in-game items available to purchase or sell in various player states of the game, opportunities to earn cryptocurrency by satisfying game playing goals, donating cryptocurrency to another player, etc. When creating a wallet, the blockchain layer submits the wallet's private key via a signing API against a signing service 231 executing on a key signing service host. In some embodiments, the signing service is the AWS Key Management Service. In response, the signing service securely stores the private key in its secure key store 232. When the blockchain layer creates a transaction against the wallet, it sends a copy of that transaction to the signing service. In response, the signing service signs the transaction with the wallet's private key, and returns it to the blockchain layer for submission by the blockchain layer to a cryptocurrency network 240, such as the Ethereum cryptocurrency network or the Polygon cryptocurrency network, using an API exposed by that cryptocurrency network. In some embodiments, the game server receives notifications from the cryptocurrency network, such as confirmations or error messages for transactions submitted by the blockchain layer to the cryptocurrency network for the player against the wallet, or other alerts relating to the wallet, such as information about other transactions submitted for the wallet by other actors; balance changes; new balances; or the passage of certain balance thresholds, etc.

FIGS. 3A-3B are a flow diagram showing a process performed by the facility in some embodiments to support cryptocurrency transactions within the host game. In this flow diagram and those described below, a rectangle in the upper left-hand corner of each process box identifies the programmatic entity that, in some embodiments, performs the act described therein. For example, this notation indicates that the following acts in this flow diagram are in some embodiments performed by software executing on the client device: 301, 302, 304, and 305, and that the following acts are in some embodiments performed by the game server: 306 and 308-311.

In act 301, the facility invokes the single sign-on API against the authentication server on the player authentication and authorization host. The invocation includes player credentials, and the authentication server responds with an SSO access token for the player, indicating that the player successfully signed in to the single sign-on service. In act 302, the facility uses the SSO access token received in act 301 to access the player's game account to retrieve the player's player ID for the host game from the authorization server. In act 303, if a player ID is returned by the authorization server, then the facility continues in act 305, else the facility continues in act 304. In act 304, the facility initiates the player's purchase, other acquisition, and/or registration of the host game in connection with a game account maintained for the player, such as by the authorization server. After act 304, the facility continues in act 302. In act 305, the facility uses the returned player ID to invoke a player's API against the game server on the game server host. In act 306, in the game server, the facility invokes the blockchain layer to determine a wallet address to which a player state smart contract maps the player's player ID. After act 306, the facility continues in act 307 via connector A. In act 307, if the player ID is mapped to a wallet address, then the facility continues in act 309, else the facility continues in act 308. In act 308, the facility creates a wallet for the player. Further details of act 308 are discussed below in connection with FIG. 6. After act 308, the facility continues to act 306 via connector B. In act 309, the facility creates a cryptocurrency transaction with respect to the wallet address. In various embodiments, this cryptocurrency transaction contains various information, which can include an identifier of the cryptocurrency, an amount of cryptocurrency, the wallet address of the player's wallet as either the source or destination of the cryptocurrency amount a different wallet address for the other of the source and destination, etc. In act 310, the facility invokes the signing API against the signing service on the key signing service host. In the invocation, the facility passes the transaction created in act 309, along with identifying information for the player such as player ID. The key signing service returns a copy of the transaction that has been signed using the private key for the player's wallet that is stored securely in the key store. In act 311, the facility calls the blockchain layer to submit the signed transaction to the cryptocurrency network. After 311, the facility continues in act 309 to handle the next cryptocurrency transaction initiated by the game server.

Those skilled in the art will appreciate that the acts shown in FIGS. 3A-3B and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

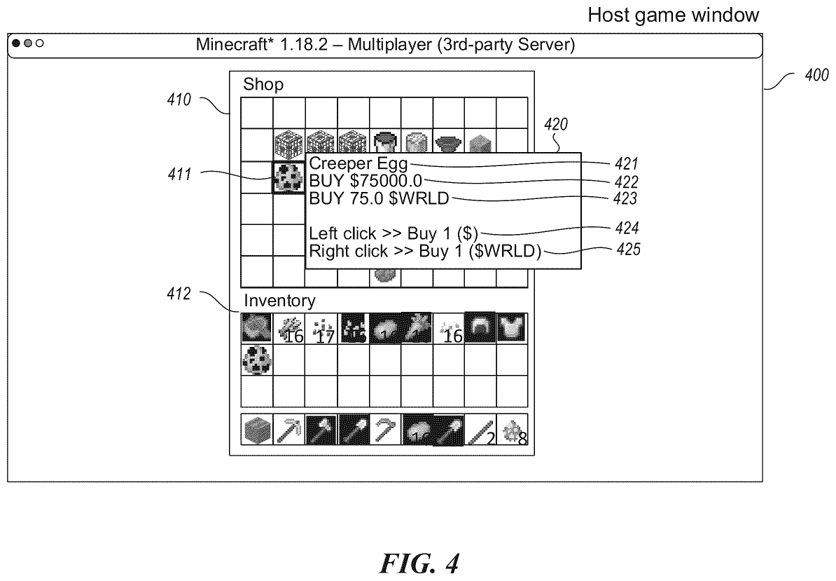

FIG. 4 is a display diagram showing a sample display presented by the facility in some embodiments to present an opportunity for a cryptocurrency transaction within the host-game. A window 400 shows visual output of the host game. When the host game identifies an opportunity to perform a cryptocurrency transaction, such as using cryptocurrency to purchase an in-game item—the host game displays a transaction window 410. In this case, the transaction window includes an array of in-game items that can be acquired by the player, i.e., added to the player's inventory 412. When the player selects a particular item 411, the host game displays a sub-window 420 including information about the item, including its name 421, a price 422 in dollars for acquiring the item, a price 423 in a gaming-specific cryptocurrency WorldCoin at which the item can be acquired, and controls and/or instructions 424-425 for buying the item using the two kinds of currency identified in prices 422 and 423. When the player follows one of these instructions or activates one of these controls, the host game initiates the corresponding transaction.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

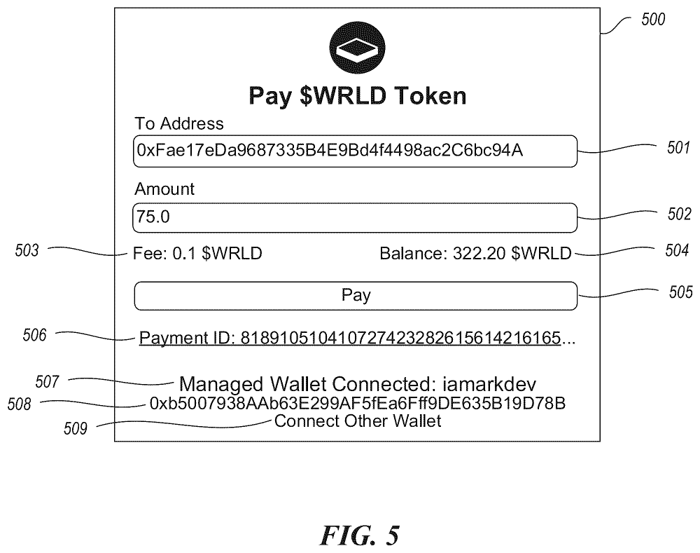

FIG. 5 is a display diagram showing a sample display presented by the facility in some embodiments to confirm an in-game cryptocurrency transaction. The facility presents a confirmation window 500 for confirming a payment in the WorldToken cryptocurrency. The confirmation window includes a wallet address 501 of the recipient of the cryptocurrency payment—the item vendor, which may be the operator and/or the designer or developer of the host game; an amount 502 of the cryptocurrency to be transferred; a transaction fee 503 to be imposed as part of the transaction; a balance 504 of the WorldToken cryptocurrency in the player's wallet; and pay control 505 to confirm and finalize the transaction. The window also shows an identifier 506 for the transaction; indications of a name 507 and wallet ID 509 of the player's wallet in which the payment will be made, and a control 509 to substitute some other wallet over which the player has control as the paying wallet for this transaction.

FIG. 6 is a flow diagram showing a process performed by the facility in some embodiments to create a wallet on behalf of a player. Notations show that, in some embodiments, act 603 is performed by the key signing server, and the other acts are performed by the facility in the game server. In act 601, the facility generates a random number to use as the private key for the new wallet. In act 602, the facility passes the wallet private key generated in act 601 to the key signing server along with the player's player ID. In act 603, the facility encrypts the wallet private key received from the gaming server and stores it in the secure key store managed by the key signing server in connection with the player's player ID. In act 604, the facility derives a wallet public key from the wallet private key generated in act 601. In act 605, the facility the facility hashes the wallet public key derived in act 604 to obtain a wallet address for the new wallet. In act 606, the facility uses the blockchain layer to update the player contract containing mappings from player IDs to the associated wallet addresses corresponding to the player ID to add a mapping from this player's player ID to the wallet address obtained in act 605. After act 606, this process concludes.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for operating a game on behalf of a player, the method comprising:
identifying an opportunity in the operation of the game to perform a cryptocurrency transaction with respect to the player;
identifying a cryptocurrency wallet belonging to the player;
creating a cryptocurrency transaction in accordance with the identified opportunity with respect to the identified cryptocurrency wallet;
causing the created cryptocurrency transaction to be signed by the identified cryptocurrency wallet; and
causing the signed cryptocurrency transaction to be posted to a public blockchain by a cryptocurrency network.

2. The method of claim 1 wherein the identified opportunity is an opportunity for the player to purchase an in-game item with an amount of a distinguished cryptocurrency contained by the cryptocurrency wallet belonging to the player, the method further comprising:
causing to be presented to the player:
information describing the in-game item;
a price of the in-game item expressed in the distinguished cryptocurrency; and
a control for effecting the purchase; and
receiving input activating the control.

3. The method of claim 1, further comprising:
determining that the player has achieved a goal in the player's play of the game, and wherein the identified opportunity is a cryptocurrency payment to the player as a reward for achieving the goal.

4. The method of claim 1 wherein the identified opportunity is an opportunity for the player to purchase an amount of a distinguished cryptocurrency using a distinct currency.

5. The method of claim 1 wherein the identified opportunity is an opportunity for the player to donate an amount of a distinguished cryptocurrency to a different player.

6. The method of claim 1 wherein the player is identified to the game by a player identifier,
and wherein identifying a cryptocurrency wallet belonging to the player comprises accessing a smart contract to retrieve a mapping maintained by the smart contract that maps from the player identifier to a wallet identifier identifying the cryptocurrency wallet belonging to the player.

7. The method of claim 1, further comprising:
before identifying the cryptocurrency wallet belonging to the player, causing the identified cryptocurrency wallet to be created on the player's behalf.

8. The method of claim 7 wherein the player is identified by a player identifier,
and wherein creating the identified cryptocurrency wallet comprises determining a wallet identifier identifying the identified cryptocurrency wallet,
the method further comprising:
causing a smart contract to maintain a mapping from the player identifier to the determined wallet identifier.

9. One or more computer memories collectively containing a game engine executable module data structure, the data structure comprising:
executable code for operating a game, the executable code containing an invocation reference to a second executable module external to the game engine executable module, the invocation reference occurring at a point in the executable code of the game engine at which an opportunity to conduct a cryptocurrency transaction involving a player of the game has been identified, such that the contents of the data structure are executable to cause the cryptocurrency transaction to be performed by the second executable module on behalf of the game's player in response to identifying the opportunity.

10. One or more instances of computer-readable media having contents configured to cause a computing system to perform a method, the method comprising:
receiving a first invocation from a game engine conveying (a) a player identifier identifying a player on behalf of whom the game engine is executing, and (b) information describing a cryptocurrency transaction to be performed with respect to the identified player;
in response to receiving the first invocation from the game engine:
accessing a smart contract to retrieve a mapping maintained by the smart contract that maps from the player identifier to a wallet identifier identifying a cryptocurrency wallet owned by the identified player;
constructing a cryptocurrency transaction comprising the retrieved wallet identifier and at least a portion of the conveyed information describing the transaction;
invoking a signing service to sign the constructed transaction with a private key for the wallet identified by the retrieved wallet identifier that is maintained securely by the signing service; and
invoking a cryptocurrency network to publish the signed transaction on a public blockchain managed by the cryptocurrency network.

11. The one or more instances of computer-readable media of claim 10, the method further comprising:
before receiving the first invocation from the game engine, receiving a second invocation from the game engine conveying the player identifier;
in response to receiving the second invocation from the game engine:
accessing the smart contract to determine that it maintains no mapping that maps from the player identifier to any wallet identifier identifying a cryptocurrency wallet owned by the identified player;
in response to the determining:
causing the cryptocurrency wallet owned by the identified player identified by the wallet identifier to be created;
causing the private key for the wallet to be maintained securely by the signing service; and
causing the smart contract to be updated to maintain a mapping from the player identifier to the wallet identifier.

12. A method in a computing system for operating a game on behalf of a player, comprising:
in the operation of the game, identifying an opportunity to conduct a cryptocurrency transaction involving the player;
in response to the identifying:
constructing the cryptocurrency transaction;
identifying a wallet belonging to the player;
invoking an external key signing service to sign the transaction using a private key of the identified wallet securely maintained by the external key signing service; and
causing the signed transaction to be posted to a public blockchain.

13. The method of claim 12 wherein causing the signed transaction to be posted to a public blockchain comprises invoking an external cryptocurrency network to post the signed transaction to the public blockchain.

14. The method of claim 12, further comprising:
before invoking the external key signing service to sign the transaction, invoking the external key signing service to securely maintain the private key of the identified wallet.

15. The method of claim 12, further comprising:
before identifying a wallet belonging to the player, invoking an external user authentication service to authenticate a connected user as the player.

16. One or more computer memories collectively storing a smart contract data structure, the data structure comprising:
a plurality of entries, each entry comprising:
information specifying a mapping from a player identifier to a wallet identifier identifying a wallet owned by a player identified by the player identifier, the identified wallet being configured to contain amounts of a cryptocurrency whose transactions are hosted by a public cryptocurrency network.

17. The one or more computer memories of claim 16 wherein, four distinct one of the plurality of entries, the distinguished entry specifies a mapping to wallet identifier identifying a wallet that contains a non-zero amount of the cryptocurrency.

18. One or more computer memories collectively storing a data structure whose contents define an instance of a game, the data structure comprising:
one or more entries, each entry corresponding to a different in-game item available for purchase within the game instance, each entry comprising information specifying:
a name of the in-game item; and
a price at which the in-game item can be purchased by players of the game instance, the price expressed in an amount of a cryptocurrency whose transactions are hosted by a public cryptocurrency network,
such that the contents of the data structure are usable to operate the game instance in such a way that, for a distinguished one of the entries, a player can purchase the in-game item to which the distinguished entry corresponds by paying the amount of the cryptocurrency specified by the distinguished entry.
